(19) United States
(12) Patent Application Publication
(10) Pub. No.: US 2012/0252476 A1
(43) Pub. Date: Oct. 4, 2012

(54) BASE STATION APPARATUS AND PROGRAM

(75) Inventor: Kenichi MURAKAMI, Osaka-shi (JP)

(73) Assignee: SUMITOMO ELECTRIC INDUSTRIES, LTD., Osaka-shi (JP)

(21) Appl. No.: 13/525,670

(22) Filed: Jun. 18, 2012

Related U.S. Application Data
(63) Continuation-in-part of application No. PCT/JP2011/053370, filed on Feb. 17, 2011.

(30) Foreign Application Priority Data
Mar. 2, 2010 (JP) 2010-045785

(51) Int. Cl. H04W 72/04

(52) U.S. Cl. 455/450

(57) ABSTRACT

A base station apparatus wherein the delay time in a call connection procedure can be reduced by use of a software process. A base station apparatus, which wireless communicates with a mobile telephone terminal, includes: a radio resource managing unit for managing radio resources for use in wireless communications; and a call connecting unit. The call connecting unit, which is provided as a function block independent of the radio resource managing unit, performs a call connection related to the mobile telephone terminal.

### CROSS-REFERENCE TO RELATED APPLICATIONS

This application is a Continuation-in-Part patent application under 37 C.F.R. §1.53(b), of pending prior International Application No. PCT/JP2011/053370, having a filing date of Feb. 17, 2011, which claims priority to Japanese Patent Application No. 2010-045785 filed Mar. 2, 2010, both of which are herein incorporated by reference in their entirety.

### TECHNICAL FIELD

The present invention relates to a base station apparatus and a program.

### BACKGROUND ART

Communications by mobile phones use radio waves. Thus, even within a communication coverage area, in a radio shadow area where radio waves from an outdoor base station (hereinafter, referred to as a “macrocell base station”) are difficult to reach (or do not reach), communications by mobile phones cannot be performed.

Hence, in order to enable the communications by mobile phones even in the radio shadow area, the construction of a communication system using a compact base station is considered.

In this communication system, a compact base station (hereinafter, referred to as a “femtocell base station”) having, as its coverage area, a very small cell (a femtocell) with a radius of the order of several meters to several tens of meters is installed in the radio shadow area.

In addition, the femtocell base station is connected to a mobile communication network of a mobile service provider through a wire communication line.

Therefore, mobile phones in the radio shadow area are connected to the mobile communication network through the femtocell base station and the wire communication line.

As a result, even in the radio shadow area, communications by mobile phones are enabled.

Note that the following Patent Literature 1 discloses a communication system including a radio base station installed in an optical communication subscriber's home. In the communication system, a signal from a mobile phone used in the subscriber's home is transmitted to a local office from the radio base station in the home through an optical communication cable and is then transmitted from the local office to various networks such as an IP network, a general telephone switching network, or a mobile communication switching network.

### CITATION LIST

### Patent Literature

Patent Literature 1: Japanese Patent Application Laid-Open No. 2004-15103

### SUMMARY OF INVENTION

### Technical Problem

An object of the present invention is, when a need arises to change an AS (Access Stratum) configuration of the base station apparatus, to avoid in advance from performing a process associated with a pre-change, old AS configuration.

### Solution to Problem

A base station apparatus according to a first aspect of the present invention is a base station apparatus that performs radio communication with a terminal, the base station apparatus including: a radio resource managing unit that manages a radio resource used for the radio communication; and a call connection processing unit that performs a call connection process for the terminal.

According to the base station apparatus according to the first aspect, the call connection processing unit can solely perform a call connection process for the terminal.

A base station apparatus according to a second aspect of the present invention is such that in the base station apparatus according to the first aspect, in particular, when a need arises to change an AS (Access Stratum) configuration of the base station apparatus, the radio resource managing unit sends out a change start notification to the call connection processing unit, the change start notification notifying a change to the AS configuration, the call connection processing unit having received the change start notification sends out a change permission notification to the radio resource managing unit, the change permission notification notifying permission to change the AS configuration, and the radio resource managing unit changes the AS configuration after receiving the change permission notification.

According to the base station apparatus according to the second aspect, the radio resource managing unit sends out a change start notification to the call connection processing unit, the call connection processing unit having received the change start notification sends out a change permission notification to the radio resource managing unit, and the radio resource managing unit changes the AS configuration after receiving the change permission notification. Accordingly, the call connection processing unit can be avoided in advance from performing a call connection process associated with a pre-change, old AS configuration.

A base station apparatus according to a third aspect of the present invention is such that in the base station apparatus according to the second aspect, in particular, the call connection processing unit having received the change start notification suspends or stops a call connection process being currently performed, and sends out the change permission notification to the radio resource managing unit.

According to the base station apparatus according to the third aspect, the call connection processing unit having received a change start notification suspends or stops a call connection process being currently performed and sends out a change permission notification to the radio resource managing unit. Accordingly, the radio resource managing unit can immediately change the AS configuration without waiting for the call connection process being currently performed by the call connection processing unit to be completed.

A base station apparatus according to a fourth aspect of the present invention is such that in the base station apparatus according to the third aspect, in particular, the radio resource managing unit sends out a change completion notification to the call connection processing unit after completion of the change to the AS configuration, the change completion notification notifying completion of the change to the AS configuration, and the call connection processing unit having received the change completion notification resumes the suspended call connection process.

According to the base station apparatus according to the fourth aspect, the radio resource managing unit sends out a change completion notification to the call connection processing unit after completion of a change to the AS configuration, and the call connection processing unit having received the change completion notification resumes the suspended call connection process. Accordingly, the call connection processing unit can properly perform the suspended call connection process using a changed, new AS configuration.

A base station apparatus according to a fifth aspect of the present invention is such that in the base station apparatus according to the fourth aspect, in particular, when the call connection processing unit having received the change completion notification resumes the suspended call connection process, the call connection processing unit generates a message to be sent out to the terminal, based on the changed AS configuration.

According to the base station apparatus according to the fifth aspect, the call connection processing unit can generate a message to be sent out to the terminal, based on the changed AS configuration.

A base station apparatus according to a sixth aspect of the present invention is such that in the base station apparatus according to the second aspect, in particular, the call connection processing unit having received the change start notification sends out the change permission notification to the radio resource managing unit after completion of a call connection process being currently performed.

According to the base station apparatus according to the sixth aspect, the call connection processing unit having received a change start notification sends out a change permission notification to the radio resource managing unit after completion of a call connection process being currently performed. Accordingly, since there is no need to suspend or stop the call connection process being currently performed, the terminal can avoid a situation in which the call connection process being performed is suddenly suspended or stopped.

A base station apparatus according to a seventh aspect of the present invention is such that in the base station apparatus according to any one of the second to sixth aspects, in particular, the base station apparatus further includes an AS configuration managing unit that accepts an AS configuration change request made to the base station apparatus from another apparatus.

Here, “another apparatus” includes SON (Self Organizing Network), O&M (Operations And Maintenance), or any upper apparatus.

According to the base station apparatus according to the seventh aspect, the AS configuration managing unit accepts an AS configuration change request made to the base station apparatus from another apparatus. Therefore, the radio resource managing unit does not need to perform a process of accepting the change request from that another apparatus, enabling a reduction in the processing load of the radio resource managing unit.

A base station apparatus according to an eighth aspect of the presents invention is such that in the base station apparatus according to any one of the first to seventh aspects, in particular, the base station apparatus further includes a memory that stores a parameter set value for a message to be sent out by the call connection processing unit to the terminal upon performing the call connection process.

According to the base station apparatus according to the eighth aspect, the memory stores a parameter set value for a message to be sent out by the call connection processing unit to the terminal. Therefore, the call connection processing unit can generate a message sent out to the terminal, based on the parameter set value stored in the memory. As a result, a process of creating a message by the call connection processing unit is simplified, enabling a further reduction in the connection delay time.

A base station apparatus according to a ninth aspect of the present invention is such that in the base station apparatus according to any one of the first to seventh aspects, in particular, the base station apparatus further includes a memory that stores a message to be sent out by the call connection processing unit to the terminal upon performing the call connection process.

According to the base station apparatus according to the ninth aspect, the memory stores a message to be sent out by the call connection processing unit to the terminal. Therefore, the call connection processing unit reads a message stored in the memory and can send out the message to the terminal. As a result, a process of creating a message by the call connection processing unit becomes unnecessary, enabling a further reduction in the connection delay time.

A base station apparatus according to a tenth aspect of the present invention is such that in the base station apparatus according to the eighth or ninth aspect, in particular, the radio resource managing unit changes the AS configuration by updating content of the memory.

According to the base station apparatus according to the tenth aspect, the call connection processing unit can obtain an appropriate message that accommodates a change to the AS configuration, by reading the content of the memory which is updated along with the change to the AS configuration.

A base station apparatus according to a second aspect of the present invention is such that in the base station apparatus according to the first aspect, in particular, the base station apparatus complies with a standard including a process related to a call connection as a process related to radio resource management, the radio resource managing unit is a functional block having functions of all processes related to the radio resource management in the standard, except for at least a function of the process related to a call connection, and the call connection processing unit is a functional block having the function of at least the process related to a call connection among the processes related to the radio resource management in the standard.

The standard is preferably LTE (Long Term Evolution). In addition, the processes related to the radio resource management are preferably RRM (Radio Resource Management) processes in 3GPP (Third Generation Partnership Project) specifications. For an LTE-support base station apparatus, since the connection delay time is limited within 100 msec by the 3GPP specifications and thus there is a great need for a reduction in connection delay time, the advantage brought about by the application of the present invention is particularly great.

A base station apparatus according to a twelfth aspect of the present invention is such that in the base station apparatus according to any one of the first to ninth aspects, in particular, the base station apparatus further includes a system information broadcasting processing unit that performs a process of broadcasting the terminal of system information.

According to the base station apparatus according to the twelfth aspect, the system information broadcasting processing unit performs a process of broadcasting the terminal of the system information. Therefore, the radio resource managing unit and the call connection processing unit do not need to perform a process of broadcasting of the system information, enabling a reduction in the processing loads of the radio resource managing unit and the call connection processing unit. By reducing the processing load of the call connection processing unit, the connection delay time is also reduced.

A base station apparatus according to a thirteenth aspect of the present invention is a base station apparatus that performs radio communication with a terminal, the base station apparatus including: a radio resource managing unit that manages a radio resource used for the radio communication; and a system information broadcasting processing unit that performs a process of broadcasting the terminal of the system information.

According to the base station apparatus according to the thirteenth aspect, the system information broadcasting processing unit performs a process of broadcasting the terminal of the system information. Therefore, the radio resource managing unit does not need to perform a process of broadcasting of the system information, enabling a reduction in the processing load of the radio resource managing unit.

A base station apparatus according to a fourteenth aspect of the present invention is such that in the base station apparatus according to the thirteenth aspect, in particular, when a need arises to change an AS (Access Stratum) configuration of the base station apparatus, the radio resource managing unit sends out a change start notification to the system information broadcasting processing unit, the change start notification notifying a change to the AS configuration, the system information broadcasting processing unit having received the change start notification sends out a change permission notification to the radio resource managing unit, the change permission notification notifying permission to change the AS configuration, and the radio resource managing unit changes the AS configuration after receiving the change permission notification.

According to the base station apparatus according to the fourteenth aspect, the radio resource managing unit sends out a change start notification to the system information broadcasting processing unit, the system information broadcasting processing unit having received the change start notification sends out a change permission notification to the radio resource managing unit, and the radio resource managing unit changes the AS configuration after receiving the change permission notification. Accordingly, the system information broadcasting processing unit can be avoided in advance from performing a broadcasting process associated with a pre-change, old AS configuration.

A base station apparatus according to a fifteenth aspect of the present invention is such that in the base station apparatus according to the fourteenth aspect, in particular, the system information broadcasting processing unit having received the change start notification suspends or stops a broadcasting process being currently performed, and sends out the change permission notification to the radio resource managing unit.

According to the base station apparatus according to the fifteenth aspect, the system information broadcasting processing unit having received a change start notification suspends or stops a broadcasting process being currently performed, and sends out a change permission notification to the radio resource managing unit. Accordingly, the radio resource managing unit can immediately change the AS configuration without waiting for the broadcasting process being currently performed by the system information broadcasting processing unit to be completed.

A base station apparatus according to a sixteenth aspect of the present invention is such that in the base station apparatus according to the fifteenth aspect, in particular, the radio resource managing unit sends out a change completion notification to the system information broadcasting processing unit after completion of the change to the AS configuration, the change completion notification notifying completion of the change to the AS configuration, and the system information broadcasting processing unit having received the change completion notification resumes the suspended broadcasting process.

According to the base station apparatus according to the sixteenth aspect, the radio resource managing unit sends out a change completion notification to the system information broadcasting processing unit after completion of a change to the AS configuration, and the system information broadcasting processing unit having received the change completion notification resumes a suspended broadcasting process. Accordingly, the system information broadcasting processing unit can properly perform the suspended broadcasting process using a changed, new AS configuration.

A base station apparatus according to a seventeenth aspect of the present invention is such that in the base station apparatus according to the sixteenth aspect, in particular, when the system information broadcasting processing unit having received the change completion notification resumes the suspended broadcasting process, the system information broadcasting processing unit generates broadcast information based on the changed AS configuration.

According to the base station apparatus according to the seventeenth aspect, broadcast information can be generated based on the changed AS configuration.

A base station apparatus according to an eighteenth aspect of the present invention is such that in the base station apparatus according to the fourteenth aspect, in particular, the system information broadcasting processing unit having received the change start notification sends out the change permission notification to the radio resource managing unit after completion of an broadcasting process being currently performed.

According to the base station apparatus according to the eighteenth aspect, the system information broadcasting processing unit having received a change start notification sends out a change permission notification to the radio resource managing unit after completion of a broadcasting process being currently performed. Accordingly, since there is no need to suspend or stop the broadcasting process being currently performed, the terminal can avoid a situation in which the broadcasting process being performed is suddenly suspended or stopped.

A base station apparatus according to a nineteenth aspect of the present invention is such that in the base station apparatus according to any one of the thirteenth to eighteenth aspects, in particular, the base station apparatus further includes an AS configuration managing unit that accepts an AS configuration change request made to the base station apparatus from another apparatus.

According to the base station apparatus according to the nineteenth aspect, the AS configuration managing unit accepts an AS configuration change request made to the base station apparatus from another apparatus. Therefore, the radio resource managing unit does not need to perform a process of accepting the change request from that another apparatus, enabling a reduction in the processing load of the radio resource managing unit. In addition, since the AS configuration managing unit is provided as a different functional block than the radio resource managing unit and the system information broadcasting processing unit, software structure can be simplified. Accordingly, when making a change to the functions of the AS configuration managing unit, only software associated with the AS configuration managing unit needs to be changed, and thus, a change to the functions can be easily made.

A base station apparatus according to a twentieth aspect of the present invention is such that in the base station apparatus according to any one of the thirteenth to nineteenth aspects, in particular, the base station apparatus further includes a memory that stores a parameter set value for broadcast information to be broadcasted of by the system information broadcasting processing unit to the terminal upon performing the broadcasting process.

According to the base station apparatus according to the twentieth aspect, the memory stores a parameter set value for broadcast information to be broadcasted of by the system information broadcasting processing unit to the terminal. Therefore, the system information broadcasting processing unit can generate broadcast information based on a parameter set value read from the memory. Accordingly, a process of creating broadcast information by the system information broadcasting processing unit is simplified, enabling a reduction in the operating period of the system information broadcasting processing unit. As a result, it is possible to avoid delay in call connection process caused by an increase in the operating period of the system information broadcasting processing unit, enabling a reduction in the connection delay time.

A base station apparatus according to a twenty-first aspect of the present invention is such that in the base station apparatus according to any one of the thirteenth to nineteenth aspects, in particular, the base station apparatus further includes a memory that stores broadcast information to be broadcasted of by the system information broadcasting processing unit to the terminal upon performing the broadcasting process.

According to the base station apparatus according to the twenty-first aspect, the memory stores broadcast information to be broadcasted of by the system information broadcasting processing unit to the terminal. Therefore, the system information broadcasting processing unit reads broadcast information stored in the memory and can inform the terminal of the broadcast information. Hence, a process of creating broadcast information by the system information broadcasting processing unit becomes unnecessary, enabling a reduction in the operating period of the system information broadcasting processing unit. As a result, it is possible to avoid delay in call connection process caused by an increase in the operating period of the system information broadcasting processing unit, enabling a reduction in the connection delay time.

A base station apparatus according to a twenty-second aspect of the present invention is such that in the base station apparatus of the twentieth or twenty-first aspect, in particular, the radio resource managing unit changes the AS configuration by updating content of the memory.

According to the base station apparatus according to the twenty-second aspect, the system information broadcasting processing unit can generate appropriate broadcast information that accommodates a change to the AS configuration, by reading the content of the memory which is updated along with the change to the AS configuration.

A program according to a twenty-third aspect of the present invention causes a computer mounted on a base station apparatus that performs radio communication with a terminal, to function as: a radio resource managing unit for managing a radio resource used for the radio communication; and a call connection processing unit for performing a call connection process for the terminal, wherein when a need arises to change an AS (Access Stratum) configuration of the base station apparatus, the radio resource managing unit sends out a change start notification to the call connection processing unit, the change start notification notifying a change to the AS configuration, the call connection processing unit having received the change start notification sends out a change permission notification to the radio resource managing unit, the change permission notification notifying permission to change the AS configuration, and the radio resource managing unit changes the AS configuration after receiving the change permission notification. The pro gram is preferably stored in a computer-readable recording medium.

According to the program according to the twenty-third aspect, the call connection processing unit can be avoided in advance from performing a call connection process associated with a pre-change, old AS configuration.

A program according to a twenty-fourth aspect of the present invention causes a computer mounted on a base station apparatus that performs radio communication with a terminal, to function as: a radio resource managing unit for managing a radio resource used for the radio communication; and a system information broadcasting processing unit for performing a process of broadcasting the terminal of system information, wherein when a need arises to change an AS (Access Stratum) configuration of the base station apparatus, the radio resource managing unit sends out a change start notification to the system information broadcasting processing unit, the change start notification notifying a change to the AS configuration, the system information broadcasting processing unit having received the change start notification sends out a change permission notification to the radio resource managing unit, the change permission notification notifying permission to change the AS configuration, and the radio resource managing unit changes the AS configuration after receiving the change permission notification. The program is preferably stored in a computer-readable recording medium.

According to the program according to the twenty-fourth aspect, the system information broadcasting processing unit can be avoided in advance from performing a broadcasting process associated with a pre-change, old AS configuration.

### Effects of the Invention

According the present invention, base station apparatuses and programs which are capable of avoiding in advance from performing a process associated with a pre-change, old AS configuration can be obtained.

### BRIEF DESCRIPTION OF DRAWINGS

FIG. 1 is a block diagram showing a configuration of a base station apparatus according to an embodiment of the present invention.

FIG. 2 is a diagram showing a configuration of a computer mounted on the base station apparatus.

FIG. 3 is a diagram showing a procedure for performing a call connection process between a call connection processing unit and a mobile phone terminal.

FIG. 4 is a diagram showing a first example of a process performed when a change request is inputted during the performance of a call connection process.

FIG. 5 is a diagram showing a second example of the process performed when a change request is inputted during the performance of a call connection process.

FIG. 6 is a diagram showing a first example of a process performed when a change request is inputted during the performance of a broadcasting process.

FIG. 7 is a diagram showing a second example of the process performed when a change request is inputted during the performance of a broadcasting process.

### DESCRIPTION OF EMBODIMENTS

At least one embodiment of the present invention will be described in detail below using the drawings. Note that those components denoted by the same reference signs in different drawings indicate the same or corresponding components.

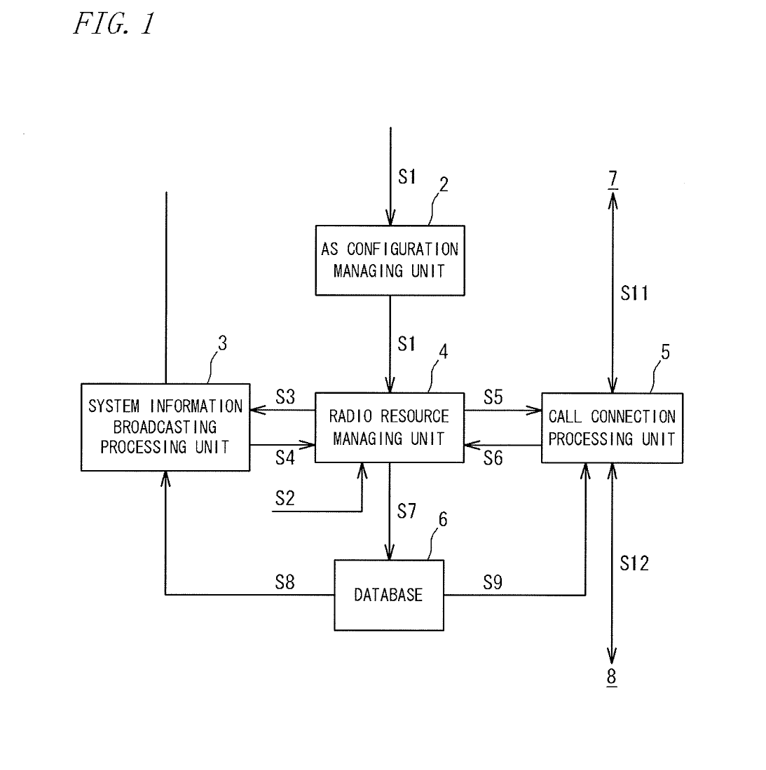

FIG. 1 is a block diagram showing a configuration of a base station apparatus 1 according to an embodiment of the present invention. FIG. 1 shows some functions associated with AS (Access Stratum) which are picked from all of the functions of the base station apparatus 1. The base station apparatus 1 is a macrocell base station (eNodeB) or a femtocell base station (Home eNodeB) which supports LTE (Long Term Evolution). Note, however, that the base station apparatus 1 may be a base station which supports W-CDMA. Note also that it is preferred that the base station apparatus 1 be a compact base station that forms a smaller cell than a macrocell, such as a femtocell base station.

The base station apparatus 1 according to the present embodiment complies with a standard that includes processes related to a call connection as processes related to radio resource management (RRM), like LTE. The base station apparatus 1 performs the above-described radio resource management (RRM) processes by a software process.

In TS36.300 V8.9.0 (JUNE-2009), there are described, as RRM functions, Connection Mobility Control, Radio Bearer Control, Radio admission Control, Dynamic Resource Allocation, Packet Scheduling, Inter-cell Interference Coordination, Load Balancing, Inter-RAT Radio Resource Management, and Subscriber Profile ID for RAT/Frequency Priority.

As shown in FIG. 1, the base station apparatus 1 is configured to include an AS configuration managing unit 2, a system information broadcasting processing unit 3, a radio resource managing unit 4, and a call connection processing unit 5. These processing units are configured as functional blocks independent of one another. In addition, the base station apparatus 1 includes a database 6 serving as a memory.

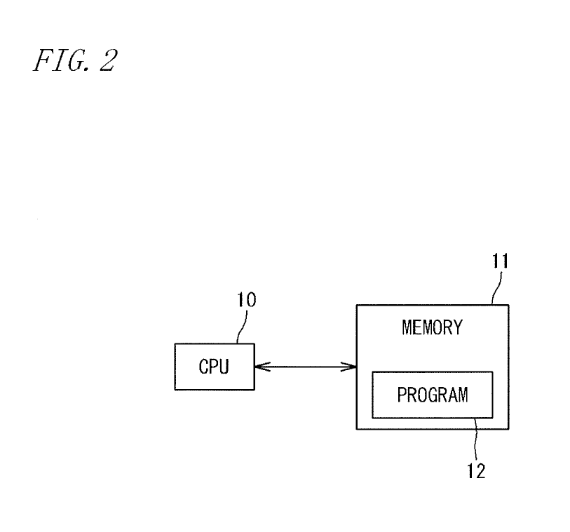

FIG. 2 is a diagram showing a configuration of a computer mounted on the base station apparatus 1. The computer includes a CPU 10 and a memory 11. The memory 11 has a program 12 stored therein. By reading the program 12 from the memory 11 and executing the program 12 by the CPU 10, the functions of the AS configuration managing unit 2, the system information broadcasting processing unit 3, the radio resource managing unit 4, and the call connection processing unit 5 which are shown in FIG. 1 are implemented. In other words, the program 12 is a program that causes the computer mounted on the base station apparatus 1 to function as the AS configuration managing unit 2, the system information broadcasting processing unit 3, the radio resource managing unit 4, and the call connection processing unit 5. Note, however, that as shown in FIG. 1 the processing units of the AS configuration managing unit 2, the system information broadcasting processing unit 3, the radio resource managing unit 4, and the call connection processing unit 5 are configured as functional blocks (Software Components) independent of one another. Hence, the program 12 is divided into a plurality of modules associated with each of the processing units. Alternatively, the program 12 may be a plurality of programs associated with each of the processing units. Alternatively, the configuration may be such that the modules or programs associated with each of the processing units are processed by different CPUs.

The call connection processing unit 5 performs a call connection process for a mobile phone terminal 8. For example, the call connection processing unit 5 transmits a message S12 for processes for RRC Connection establishment control, radio bearer establishment control, etc., to the terminal 8.

In addition, the call connection processing unit 5 transmits a higher layer message S11 to an MME (Mobility Management Entity) 7 which is a network side apparatus.

The call connection processing unit 5 corresponds to functions such as Connection Mobility Control and Radio Bearer Control which are picked from the RRM (Radio Resource Management) functions described in 3GPP (Third Generation Partnership Project) specifications (TS36.300 V8.9.0). Connection Mobility Control and Radio Bearer Control are the functions of processes required for a call connection process among the functions of RRM processes described in the 3GPP specifications.

The call connection processing unit 5 does not have Radio admission Control, Dynamic Resource Allocation, Packet Scheduling, Inter-cell Interference Coordination, Load Balancing, Inter-RAT Radio Resource Management, and Subscriber Profile ID for RAT/Frequency Priority functions which are functions not required for a call connection process among the functions of the RRM processes described in the 3GPP specifications.

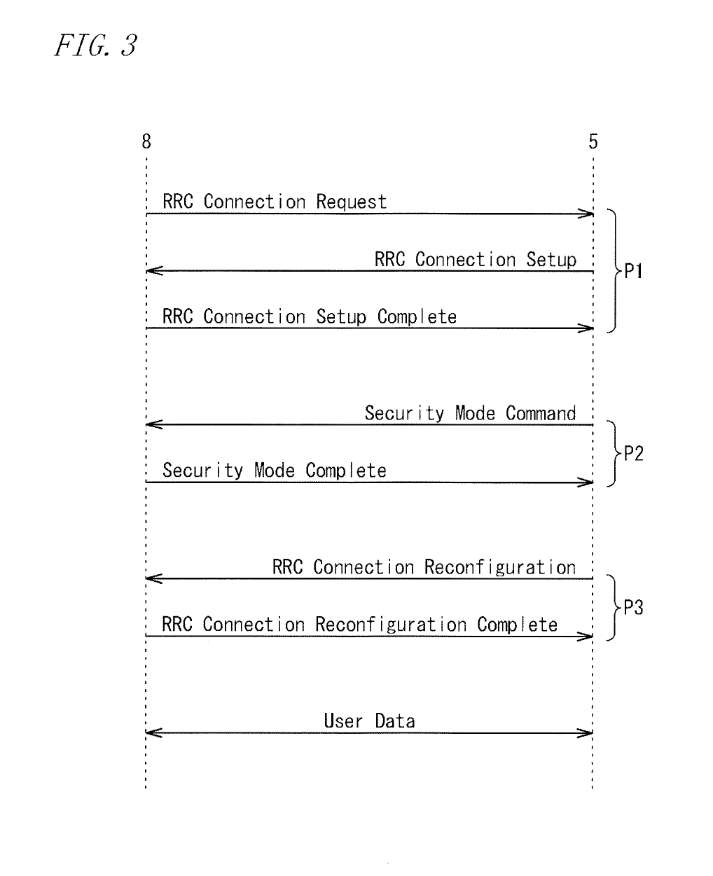

FIG. 3 is a diagram showing a procedure for performing a call connection process between the call connection processing unit 5 and the mobile phone terminal 8. First, during a period P1, RRC connection establishment is performed. Specifically, an RRC Connection Request is transmitted to the call connection processing unit 5 from the mobile phone terminal 8. Then, an RRC Connection Setup is transmitted to the mobile phone terminal 8 from the call connection processing unit 5. Then, an RRC Connection Setup Complete is transmitted to the call connection processing unit 5 from the mobile phone terminal 8.

Then, during a period P2, Security Mode setting is performed. Specifically, a Security Mode Command is transmitted to the mobile phone terminal 8 from the call connection processing unit 5. Then, a Security Mode Complete is transmitted to the call connection processing unit 5 from the mobile phone terminal 8.

Then, during a period P3, user data logical path establishment is performed. Specifically, an RRC Connection Reconfiguration is transmitted to the mobile phone terminal 8 from the call connection processing unit 5. Then, an RRC Connection Reconfiguration Complete is transmitted to the call connection processing unit 5 from the mobile phone terminal 8.

Here, the database 6 shown in FIG. 1 stores parameter set values for creating messages to be transmitted to the mobile phone terminal 8 from the call connection processing unit 5. The stored parameter set values include various information about MAC configuration, PHY configuration, etc., such as a frequency band used, logical channel configuration, physical channel configuration, and the maximum number of simultaneous transmissions. Most of these parameters are determined according to the configuration (AS configuration) of the radio base station 1 and thus the values of the parameters do not dynamically change unless the operating conditions of the base station apparatus 1 change. The call connection processing unit 5 reads parameter set values from the database 6 as data S9 and thereby generates a message based on the read parameter set values. For example, an RRC Connection Setup shown in FIG. 3 includes, as its IE (Information Element), RadioResourceConfigDedicated-SRB1 (MAC configuration information and/or PHY configuration information) which is required by the mobile phone terminal 8 to establish an SRB1 (Signaling Radio Bearer 1). Upon creating an RRC Connection Setup, the call connection processing unit 5 reads parameter set values from the database 6 as data S9 and thereby sets RadioResourceConfigDedicated-SRB1 based on the read parameter set values. Note that for other messages (Security Mode Command and RRC Connection Reconfiguration) shown in FIG. 3, too, likewise, the call connection processing unit 5 generates these messages based on the parameter set values read from the database 6.

Referring to FIG. 1, the system information broadcasting processing unit 3 broadcasts the mobile phone terminal 8 of each of pieces of system information such as an MIB (Master Information Block) and an SIB (System Information Block) at respective predetermined cycles. Parameter set values similar to those described above for creating system information are stored in the database 6. The system information broadcasting processing unit 3 reads parameter set values from the database 6 as data S8 and thereby generates system information to be broadcasted (broadcast information) based on the read parameter set values.

The AS configuration managing unit 2 manages the AS configuration of the base station apparatus 1 and accepts an AS configuration change request S1 made to the base station apparatus 1 from SON (Self Organizing Network), O&M (Operations and Maintenance), or an upper apparatus in a communication network. The AS configuration managing unit 2 collectively accepts an AS configuration change request SQ made from an external factor such as SON, O&M, or the upper apparatus. The AS configuration managing unit 2 does not perform an AS configuration change process itself, but inputs the accepted change request S1 to the radio resource managing unit 4. In addition, an AS configuration change request S2 from a lower layer such as MAC or PHY is inputted to the radio resource managing unit 4.

The radio resource managing unit 4 manages a radio resource used for radio communication between the base station apparatus 1 and the mobile phone terminal 8, and changes the AS configuration by updating information (including the above-described parameter set values) stored in the database 6, based on the change request S1 or S2. Therefore, when the information stored in the database 6 is updated according to the content of change specified by the change request S1 or S2, the parameter set values (data S9 or S8) read from the database 6 by the call connection processing unit 5 or the system information broadcasting processing unit 3 also change.

Since the radio resource managing unit 4 operates independently of the call connection processing unit 5 and the system information broadcasting processing unit 3, the radio resource managing unit 4 has the function of notifying the call connection processing unit 5 and/or the system information broadcasting processing unit 3 of an update to the database 6 (a change start notification) before updating the database 6. After the radio resource managing unit 4 notifies an update to the database 6 (a change start notification), the radio resource managing unit 4 waits for a response (a change permission notification) from the call connection processing unit 5 and/or the system information broadcasting processing unit 3 and then updates the database 6. Furthermore, since the call connection processing unit 5 and/or the system information broadcasting processing unit 3 suspend(s) or stop(s) their processes during the update to the database 6, the radio resource managing unit 5 notifies completion of the update to the database 6 (a change completion notification) after the update to the database 6.

Note that various information stored in the database 6 can be rewritten only by the radio resource managing unit 4 and rewriting from other processing units is prohibited. Note, however, that other processing units (the call connection processing unit 5 and/or the system information broadcasting processing unit 3) can read the data in the database 6.

The radio resource managing unit 4 corresponds to functions such as Radio Admission Control, Dynamic Resource Allocation, Packet Scheduling, Inter-cell Interference Coordination, Load Balancing, and Inter-RAT Radio Resource Management which are picked from the RRM functions described in the 3GPP specifications. That is, in the present embodiment, RRM functions to be owned by the radio resource managing unit 4 include all of the functions of the RRM processes described in the 3GPP specifications, except for the functions of the Connection Mobility Control and Radio Bearer Control functions which are related to a call connection process, and the Subscriber Profile ID for RAT/Frequency Priority.

Note that information about a subscriber profile (Subscriber Profile ID for RAT/Frequency Priority) is managed with other data by the database 6 which is provided separately from the radio resource managing unit 4 and the call connection processing unit 5.

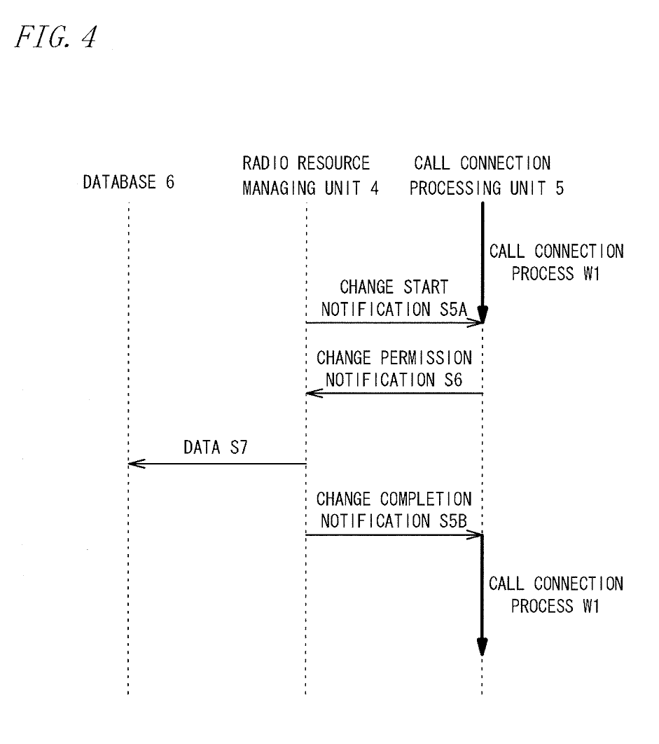

FIG. 4 is a diagram showing a first example of a process performed when a change request S1 or a change request S2 is inputted to the radio resource managing unit 4 in the middle of the call connection processing unit 5 performing a call connection process W1.

First, the radio resource managing unit 4 having received a change request S1 or S2 sends out a change start notification S5A notifying a change to the AS configuration, to the call connection processing unit 5. Then, the call connection processing unit 5 having received the change start notification S5A suspends a call connection process W1 being performed, and sends out a change permission notification S6 notifying permission to change the AS configuration, to the radio resource managing unit 4. Then, the radio resource managing unit 4 having received the change permission notification S6 changes the AS configuration of the base station apparatus 1 based on the change request S1 or S2, and accesses the database 6 to thereby rewrite the information by data S7 according to the content of the change to the AS configuration.

For example, when the content of the change to the AS configuration is a change to the MAC configuration of the base station apparatus 1, of the parameter set values in the database 6, values related to the MAC configuration are changed. The values related to the MAC configuration include, for example, values related to MAC-MainConfig-SRB included in RadioResourceConfigDedicated-SRB1 in RRC Connection Setup, or information for generating the values. The values related to MAC-MainConfig-SRB include maxHARQ-TX, periodicBSR-Timer, retxBSR-Timer, TTiBundling, etc.

Then, the radio resource managing unit 4 sends out a change completion notification S5B notifying completion of the change to the AS configuration, to the call connection processing unit 5. Then, the call connection processing unit 5 having received the change completion notification S5B resumes the suspended call connection process W1 from the suspended point. Note that the call connection processing unit 5 may stop the call connection process W1 instead of suspending it. In this case, the stopped call connection process W1 may be started over again after completion of the change to the AS configuration. The call connection processing unit 5 can generate a message for a call connection process using parameter set values (maxHARQ-Tx, periodicBSR-Timer, retxBSR-Timer, TTiBundling, etc.) obtained after the change to the AS configuration, by accessing the database 6 after receiving the change completion notification S5B.

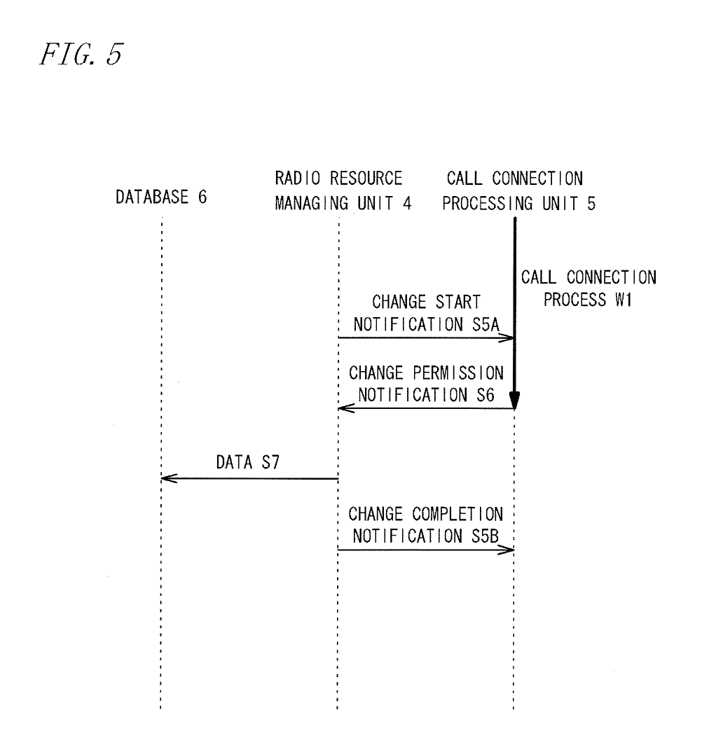

FIG. 5 is a diagram showing a second example of the process performed when a change request S1 or a change request S2 is inputted to the radio resource managing unit 4 in the middle of the call connection processing unit 5 performing a call connection process W1. First, the radio resource managing unit 4 having received a change request S1 or S2 sends out a change start notification S5A to the call connection processing unit 5. Then, the call connection processing unit 5 having received the change start notification S5A continues a call connection process W1 being performed without suspending or stopping it, and sends out a change permission notification S6 to the radio resource managing unit 4 after completion of the performance of the call connection process W1. Then, the radio resource managing unit 4 having received the change permission notification S6 changes the AS configuration of the base station apparatus 1 based on the change request S1 or S2, and accesses the database 6 to rewrite the information by data S7 according to the content of the change to the AS configuration. Then, the radio resource managing unit 4 sends out a change completion notification S5B to the call connection processing unit 5.

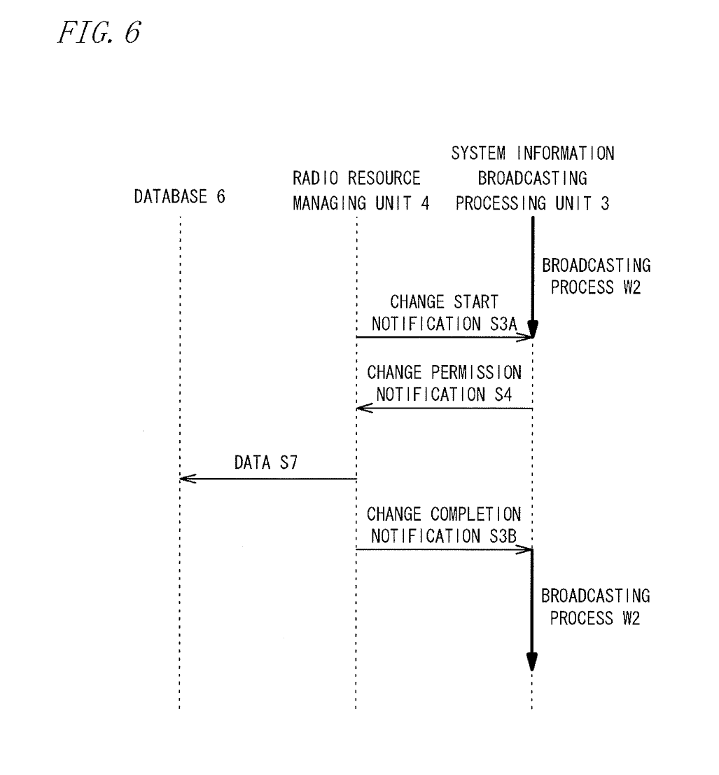

FIG. 6 is a diagram showing a first example of a process performed when a change request S1 or a change request S2 is inputted to the radio resource managing unit 4 in the middle of the system information broadcasting processing unit 3 performing a broadcasting process W2. First, the radio resource managing unit 4 having received a change request S1 or S2 sends out a change start notification S3A notifying a change to the AS configuration, to the system information broadcasting processing unit 3. Then, the system information broadcasting processing unit 3 having received the change start notification S3A suspends a broadcasting process W2 being performed, and sends out a change permission notification S4 notifying permission to change the AS configuration, to the radio resource managing unit 4. Then, the radio resource managing unit 4 having received the change permission notification S4 changes the AS configuration of the base station apparatus 1 based on the change request S1 or S2, and accesses the database 6 to rewrite the information by data S7 according to the content of the change to the AS configuration. Then, the radio resource managing unit 4 sends out a change completion notification S3B notifying completion of the change to the AS configuration, to the system information broadcasting processing unit 3. Then, the system information broadcasting processing unit 3 having received the change completion notification S3B resumes the suspended broadcasting process W2 from the suspended point.

Note that the system information broadcasting processing unit 3 may stop the broadcasting process W2 instead of suspending it. In this case, the stopped broadcasting process W2 may be started over again after completion of the change to the AS configuration. The system information broadcasting processing unit 3 can generate system information (broadcast information) using parameter set values obtained after the change to the AS configuration, by accessing the database 6 after receiving the change completion notification S3B. Note, however, that since a system information broadcasting process is periodically and repeatedly performed, the stopped broadcasting process W2 does not need to be started over again.

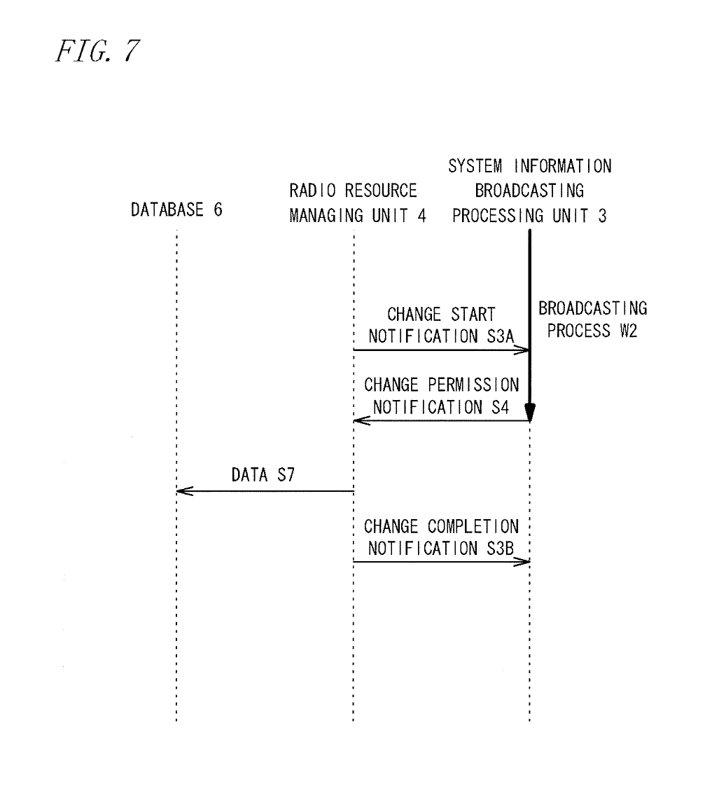

FIG. 7 is a diagram showing a second example of the process performed when a change request S1 or a change request S2 is inputted to the radio resource managing unit 4 in the middle of the system information broadcasting processing unit 3 performing a broadcasting process W2. First, the radio resource managing unit 4 having received a change request S1 or S2 sends out a change start notification S3A to the system information broadcasting processing unit 3. Then, the system information broadcasting processing unit 3 having received the change start notification S3A continues an broadcasting process W2 being performed without suspending or stopping it, and sends out a change permission notification S4 to the radio resource managing unit 4 after completion of the performance of the broadcasting process W2. Then, the radio resource managing unit 4 having received the change permission notification S4 changes the AS configuration of the base station apparatus 1 based on the change request S1 or S2, and accesses the database 6 to rewrite the information by data S7 according to the content of the change to the AS configuration. Then, the radio resource managing unit 4 sends out a change completion notification S3B to the system information broadcasting processing unit 3.

According to the base station apparatus 1 according to the present embodiment, the call connection processing unit 5 is provided as a functional block independent of the radio resource managing unit 4. Therefore, the call connection processing unit 5 can solely perform a call connection process for the mobile phone terminal 8 and thus the call connection process is not delayed due to the influence of radio resource management which is not directly related to a call connection, enabling a reduction in connection delay time. That is, in the present embodiment, Connection Mobility Control and Radio Bearer Control which are required for a call connection process are separated from the radio resource managing unit 4, which eliminates the need for the call connection processing unit 5 to make a determination as to the necessity of processes related to radio resource management other than Connection Mobility Control and Radio Bearer Control. Accordingly, overhead in connection with such a determination as to the necessity can be eliminated, enabling a reduction in connection delay time.

In addition, since the radio resource managing unit 4 and the call connection processing unit 5 are provided as different functional blocks, software structure can be simplified. Therefore, when making a change to the functions of the radio resource managing unit 4, only software associated with the radio resource managing unit 4 needs to be changed, and when making a change to the functions of the call connection processing unit 5, only software associated with the call connection processing unit 5 needs to be changed. Accordingly, a change to the functions can be easily made.

In addition, the base station apparatus 1 according to the present embodiment is a radio base station which supports LTE. For an LTE-support base station apparatus, since the connection delay time is limited within 100 msec by the 3GPP specifications and thus there is a great need for a reduction in connection delay time, the advantage brought about by the application of the present invention is particularly great.

In addition, according to the base station apparatus 1 of the present embodiment, as shown in FIGS. 4 and 5, the radio resource managing unit 4 sends out a change start notification S5A to the call connection processing unit 5, the call connection processing unit 5 having received the change start notification S5A sends out a change permission notification S6 to the radio resource managing unit 4, and the radio resource managing unit 4 changes the AS configuration after receiving the change permission notification S6. Accordingly, the call connection processing unit 5 can be avoided in advance from performing a call connection process based on parameter set values set for a pre-change, old AS configuration.

In addition, according to the base station apparatus 1 of the present embodiment, as shown in FIG. 4, the call connection processing unit 5 having received a change start notification S5A suspends or stops a call connection process W1 being currently performed, and sends out a change permission notification S6 to the radio resource managing unit 4. Accordingly, the radio resource managing unit 4 can immediately change the AS configuration without waiting for the call connection process W1 being currently performed by the call connection processing unit 5 to be completed.

In addition, according to the base station apparatus 1 of the present embodiment, as shown in FIG. 4, the radio resource managing unit 4 sends out a change completion notification S5B to the call connection processing unit 5 after completion of a change to the AS configuration, and the call connection processing unit 5 having received the change completion notification S5B resumes a suspended call connection process W1. Accordingly, the call connection processing unit 5 can properly perform the suspended call connection process W1 based on parameter set values set for a changed, new AS configuration.

In addition, according to the base station apparatus 1 of the present embodiment, as shown in FIG. 5, the call connection processing unit 5 having received a change start notification S5A sends out a change permission notification S6 to the radio resource managing unit 4 after completion of a call connection process W1 being currently performed. Accordingly, since there is no need to suspend or stop the call connection process W1 being currently performed, the mobile phone terminal 8 can avoid a situation in which the call connection process W1 being performed is suddenly suspended or stopped.

In addition, according to the base station apparatus 1 of the present embodiment, the AS configuration managing unit 2 accepts an AS configuration change request S1 made to the base station apparatus 1 from another apparatus (SON, O&M, or any upper apparatus). Therefore, the radio resource managing unit 4 does not need to perform a process of accepting the change request S1 from that another apparatus, enabling a reduction in the processing load of the radio resource managing unit 4. In addition, since the AS configuration managing unit 2 is provided as a different functional block than the radio resource managing unit 4 and the call connection processing unit 5, software structure can be simplified. Accordingly, when making a change to the functions of the AS configuration managing unit 2, only software associated with the AS configuration managing unit 2 needs to be changed, and thus, a change to the functions can be easily made.

In addition, according to the base station apparatus 1 of the present embodiment, the database 6 stores parameter set values for messages to be sent out from the call connection processing unit 5 to the mobile phone terminal 8. Therefore, the call connection processing unit 5 can generate messages sent out to the mobile phone terminal 8, based on the parameter set values stored in the database 6. As a result, a process of creating messages by the call connection processing unit 5 is simplified, enabling a further reduction in connection delay time.

In addition, according to the base station apparatus 1 of the present embodiment, the system information broadcasting processing unit 3 performs a process of broadcasting the mobile phone terminal 8 of system information. Therefore, the radio resource managing unit 4 and the call connection processing unit 5 do not need to perform a process of broadcasting of system information, enabling a reduction in the processing loads of the radio resource managing unit 4 and the call connection processing unit 5. By reducing the processing load of the call connection processing unit 5, the connection delay time is also reduced. In addition, since the system information broadcasting processing unit 3 is provided as a different functional block than the radio resource managing unit 4 and the call connection processing unit 5, software structure can be simplified. Accordingly, when making a change to the functions of the system information broadcasting processing unit 3, only software associated with the system information broadcasting processing unit 3 needs to be changed, and thus, a change to the functions can be easily made.

In addition, according to the base station apparatus 1 of the present embodiment, as shown in FIGS. 6 and 7, the radio resource managing unit 4 sends out a change start notification S3A to the system information broadcasting processing unit 3, the system information broadcasting processing unit 3 having received the change start notification S3A sends out a change permission notification S4 to the radio resource managing unit 4, and the radio resource managing unit 4 changes the AS configuration after receiving the change permission notification S4. Accordingly, the system information broadcasting processing unit 3 can be avoided in advance from performing a broadcasting process based on parameter set values set for a pre-change, old AS configuration.

In addition, according to the base station apparatus 1 of the present embodiment, as shown in FIG. 6, the system information broadcasting processing unit 3 having received a change start notification S3A suspends or stops a broadcasting process W2 being currently performed, and sends out a change permission notification S4 to the radio resource managing unit 4. Accordingly, the radio resource managing unit 4 can immediately change the AS configuration without waiting for the broadcasting process W2 being currently performed by the system information broadcasting processing unit 3 to be completed.

In addition, according to the base station apparatus 1 of the present embodiment, as shown in FIG. 6, the radio resource managing unit 4 sends out a change completion notification S3B to the system information broadcasting processing unit 3 after completion of a change to the AS configuration, and the system information broadcasting processing unit 3 having received the change completion notification S3B resumes a suspended broadcasting process W2. Accordingly, the system information broadcasting processing unit 3 can properly perform the suspended broadcasting process W2 based on parameter set values set for a changed, new AS configuration.

In addition, according to the base station apparatus 1 of the present embodiment, as shown in FIG. 7, the system information broadcasting processing unit 3 having received a change start notification S3A sends out a change permission notification S4 to the radio resource managing unit 4 after completion of a broadcasting process W2 being currently performed. Accordingly, since there is no need to suspend or stop the broadcasting process W2 being currently performed, the mobile phone terminal 8 can avoid a situation in which the broadcasting process W2 being performed is suddenly suspended or stopped.

In addition, according to the base station apparatus 1 of the present embodiment, the database 6 stores parameter set values for broadcast information which is broadcasted by the system information broadcasting processing unit 3 to the mobile phone terminal 8. Therefore, the system information broadcasting processing unit 3 can generate broadcast information based on parameter set values read from the database 6. Accordingly, a process of creating broadcast information by the system information broadcasting processing unit 3 is simplified, enabling a reduction in the operating period of the system information broadcasting processing unit 3. As a result, it is possible to avoid delay in call connection process caused by an increase in the operating period of the system information broadcasting processing unit 3, enabling a reduction in connection delay time.

### <First Variant>

In the above description, the database 6 stores parameter set values and the call connection processing unit 5 reads the parameter set values from the database 6 and thereby generates a message based on the read parameter set values. Instead of this, messages themselves may be stored in the database 6 and the call connection processing unit 5 may read a message from the database 6 and transmit the read message to the mobile phone terminal 8. Here, when there is a change to the AS configuration, the radio resource managing unit 4 updates the contents of the messages stored in the database 6, according to the content of the change.

In addition, of the messages stored in the database 6, an IE (e.g., rrc-TransactionIDentifier) which is likely to dynamically change for each message is set as an editing target area. The database 6 having received a message read request from the call connection processing unit 5 notifies the call connection processing unit 5 of the address of an area set as an editing target area, whereby the call connection processing unit 5 can identify the editing target area. The call connection processing unit 5 reads a message from the database 6 and thereafter edits the content of the editing target area, and then transmits the edited message to the mobile phone terminal 8.

According to the first variant, the database 6 stores messages to be sent out by the call connection processing unit 5 to the mobile phone terminal 8. Therefore, the call connection processing unit 5 reads a message stored in the database 6 and can send out the message to the mobile phone terminal 8. As a result, a process of creating a message by the call connection processing unit 5 becomes unnecessary, enabling a further reduction in connection delay time.

### <Second Variant>

In the above description, the database 6 stores parameter set values and the system information broadcasting processing unit 3 reads parameter set values from the database 6 and thereby generates system information based on the read parameter set values. Instead of this, system information itself may be stored in the database 6 and the system information broadcasting processing unit 3 may read system information from the database 6 and inform the mobile phone terminal 8 of the read system information. Here, when there is a change to the AS configuration, the radio resource managing unit 4 updates the content of the system information stored in the database 6, according to the content of the change.

In addition, as in the above-described first variant, of the system information stored in the database 6, an IE which is likely to dynamically change for each system information is set as an editing target area. The database 6 having received a system information read request from the system information broadcasting processing unit 3 informs the call connection processing unit 5 of the address of an area set as an editing target area, whereby the system information broadcasting processing unit 3 can identify the editing target area. The system information broadcasting processing unit 3 reads system information from the database 6 and thereafter edits the content of the editing target area, and then broadcasts the mobile phone terminal 8 of the edited system information.

According to the second variant, the database 6 stores system information to be broadcasted by the call connection processing unit 5 to the mobile phone terminal 8. Therefore, the system information broadcasting processing unit 3 reads system information stored in the database 6 and can broadcast the mobile phone terminal 8 of the system information. As a result, a process of creating system information by the system information broadcasting processing unit 3 becomes unnecessary, enabling a reduction in the operating period of the system information broadcasting processing unit 3. As a result, it is possible to avoid delay in call connection process caused by an increase in the operating period of the system information broadcasting processing unit 3, enabling a reduction in connection delay time.

Note that the embodiment disclosed herein is to be considered in all respects as illustrative and not restrictive. The scope of the present invention is indicated by the appended claims rather than by the foregoing meaning, and all changes which come within the meaning and range of equivalency of the claims are therefore intended to be embraced therein.

### REFERENCE SIGNS LIST

1: BASE STATION APPARATUS

2: AS CONFIGURATION MANAGING UNIT

3: SYSTEM INFORMATION BROADCATING PROCESSING UNIT

4: RADIO RESOURCE MANAGING UNIT

5: CALL CONNECTION PROCESSING UNIT

6: DATABASE

12: PROGRAM

1. A base station apparatus that performs radio communication with a terminal, the base station apparatus comprising:
a radio resource managing unit that manages a radio resource used for the radio communication; and
a call connection processing unit that performs a call connection process for the terminal, wherein
when a need arises to change an AS (Access Stratum) configuration of the base station apparatus,
the radio resource managing unit sends out a change start notification to the call connection processing unit, the change start notification notifying a change to the AS configuration,
the call connection processing unit having received the change start notification sends out a change permission notification to the radio resource managing unit, the change permission notification notifying permission to change the AS configuration, and
the radio resource managing unit changes the AS configuration after receiving the change permission notification.

2. The base station apparatus according to claim 1, wherein
the call connection processing unit having received the change start notification suspends or stops a call connection process being currently performed, and sends out the change permission notification to the radio resource managing unit.

3. The base station apparatus according to claim 2, wherein
the radio resource managing unit sends out a change completion notification to the call connection processing unit after completion of the change to the AS configuration, the change completion notification notifying completion of the change to the AS configuration, and
the call connection processing unit having received the change completion notification resumes the suspended call connection process.

4. The base station apparatus according to claim 3, wherein
when the call connection processing unit having received the change completion notification resumes the suspended call connection process, the call connection processing unit generates a message to be sent out to the terminal, based on the changed AS configuration.

5. The base station apparatus according to claim 1, wherein
the call connection processing unit having received the change start notification sends out the change permission notification to the radio resource managing unit after completion of a call connection process being currently performed.

6. The base station apparatus according to claim 1, further comprising an AS configuration managing unit that accepts an AS configuration change request made to the base station apparatus from another apparatus.

7. The base station apparatus according to claim 1, further comprising a memory that stores a parameter set value for a message to be sent out by the call connection processing unit to the terminal upon performing the call connection process.

8. The base station apparatus according to claim 1, further comprising a memory that stores the message to be sent out by the call connection processing unit to the terminal upon performing the call connection process.

9. The base station apparatus according to claim 7, wherein
the radio resource managing unit changes the AS configuration by updating content of the memory.

10. The base station apparatus according to claim 1, wherein
the base station apparatus complies with a standard including a process related to a call connection as a process related to radio resource management,
the radio resource managing unit is a functional block having functions of processes related to the radio resource management in the standard, except for at least a function of the process related to the call connection, and
the call connection processing unit is a functional block having the function of at least the process related to the call connection among the processes related to the radio resource management in the standard.

11. The base station apparatus according to claim 1, wherein
the radio resource managing unit includes functions such as Radio Admission Control, Dynamic Resource Allocation, Packet Scheduling, Inter-cell Interference Coordination, Load Balancing and Inter-RAT Radio Resource Management described in 3GPP (Third Generation Partnership Project) specifications.

12. The base station apparatus according to claim 1, wherein
the call connection processing unit includes functions such as Connection Mobility Control and Radio Bearer Control described in 3GPP (Third Generation Partnership Project) specifications.

13. The base station apparatus according to claim 1, wherein
the change to the AS configuration includes a change of MAC configuration of the base station apparatus.

14. The base station apparatus according to claim 6, wherein
the another apparatus is SON (Self Organizing Network), O&M (Operations And Maintenance), or any upper apparatus in a communication network connected to the base station apparatus.

15. The base station apparatus according to claim 7, wherein
the message is a RRC Connection Setup and the parameter set values are information about MAC configuration and/or PHY configuration.

16. A base station apparatus that performs radio communication with a terminal, the base station apparatus comprising:
a radio resource managing unit that manages a radio resource used for the radio communication; and
a system information broadcasting processing unit that performs a system information broadcasting process for the terminal, wherein
when a need arises to change an AS (Access Stratum) configuration of the base station apparatus,
the radio resource managing unit sends out a change start notification to the system information broadcasting processing unit, the change start notification notifying a change to the AS configuration,
the system information broadcasting processing unit having received the change start notification sends out a change permission notification to the radio resource managing unit, the change permission notification notifying permission to change the AS configuration, and
the radio resource managing unit changes the AS configuration after receiving the change permission notification.

17. The base station apparatus according to claim 16, wherein
the system information broadcasting processing unit having received the change start notification suspends or stops a broadcasting process being currently performed, and sends out the change permission notification to the radio resource managing unit.

18. The base station apparatus according to claim 17, wherein
the radio resource managing unit sends out a change completion notification to the system information broadcasting processing unit after completion of the change to the AS configuration, the change completion notification notifying completion of the change to the AS configuration, and
the system information broadcasting processing unit having received the change completion notification resumes the suspended broadcasting process.

19. The base station apparatus according to claim 18, wherein
when the system information broadcasting processing unit having received the change completion notification resumes the suspended broadcasting process,
the system information broadcasting processing unit generates broadcast information based on the changed AS configuration.

20. The base station apparatus according to claim 16, wherein
the system information broadcasting processing unit having received the change start notification sends out the change permission notification to the radio resource managing unit after completion of a broadcasting process being currently performed.

21. The base station apparatus according to claim 16, further comprising an AS configuration managing unit that accepts an AS configuration change request made to the base station apparatus from another apparatus, the AS configuration managing unit being provided as a functional block independent of the radio resource managing unit and the system information broadcasting processing unit.

22. The base station apparatus according to claim 16, further comprising a memory that stores a parameter set value for broadcast information to be broadcasted of by the system information broadcasting processing unit to the terminal upon performing the broadcasting process.

23. The base station apparatus according to claim 16, further comprising a memory that stores broadcast information to be broadcasted of by the system information broadcasting processing unit to the terminal upon performing the broadcasting process.

24. The base station apparatus according to claim 22, wherein
the radio resource managing unit changes the AS configuration by updating content of the memory.

25. A program causing a computer mounted on a base station apparatus that performs radio communication with a terminal, to function as:
a radio resource managing unit for managing a radio resource used for the radio communication; and
a call connection processing unit for performing a call connection process for the terminal, wherein
when a need arises to change an AS (Access Stratum) configuration of the base station apparatus,
the radio resource managing unit sends out a change start notification to the call connection processing unit, the change start notification notifying a change to the AS configuration,
the call connection processing unit having received the change start notification sends out a change permission notification to the radio resource managing unit, the change permission notification notifying permission to change the AS configuration, and
the radio resource managing unit changes the AS configuration after receiving the change permission notification.

26. A program causing a computer mounted on a base station apparatus that performs radio communication with a terminal, to function as:
a radio resource managing unit for managing a radio resource used for the radio communication; and
a system information broadcasting processing unit for performing a process of broadcasting the terminal of system information, wherein
when a need arises to change an AS (Access Stratum) configuration of the base station apparatus,
the radio resource managing unit sends out a change start notification to the system information broadcasting processing unit, the change start notification notifying a change to the AS configuration,
the system information broadcasting processing unit having received the change start notification sends out a change permission notification to the radio resource managing unit, the change permission notification notifying permission to change the AS configuration, and
the radio resource managing unit changes the AS configuration after receiving the change permission notification.
